(19) United States
(12) Patent Application Publication
(10) Pub. No.: US 2021/0211608 A1
(43) Pub. Date: Jul. 8, 2021

(54) REMOTE GRAVESITE EXPERIENCE SYSTEM

(71) Applicant: Donna Michelman Greenberg, Boca Raton, FL (US)

(72) Inventor: Donna Michelman Greenberg, Boca Raton, FL (US)

(21) Appl. No.: 17/141,006

(22) Filed: Jan. 4, 2021

Related U.S. Application Data
(60) Provisional application No. 62/956,904, filed on Jan. 3, 2020.

(51) Int. Cl. H04N 7/04; E04H 13/00; H04N 5/232; G06F 16/74; A47G 33/00; G06F 16/64

(52) U.S. Cl. CPC H04N 7/04; E04H 13/001; H04N 5/23216; H04L 65/4038; A47G 33/008; G06F 16/64; G06F 16/74

(57) ABSTRACT

A remote gravesite experience system includes a website having an associated server that is communicably coupled to receive information and control at least one feature associated with a graveyard that includes a plurality of gravesites each including a gravestone including a first gravesite comprising a first gravestone. The graveyard has at least a first camera having a first field-of-view (FOV) positioned for viewing the first gravesite. The website is configured for a user having a computing device including a processor, and associated memory, a transceiver, and a display screen, for the computing device initiating a connection over a network to the website. The website is configured for controlling access to the first FOV, and for the user selecting to view on the display screen the first gravesite provided by the first FOV.

### CROSS-REFERENCE TO RELATED APPLICATIONS

This application claims priority to and the benefit of U.S. Provisional Patent Application No. 62/956,904 entitled “Remote Gravesite Experience”, which was filed on Jan. 3, 2020, that is herein incorporated by reference in its entirety.

### FIELD

This Disclosure relates to graveyards and graveyard systems including gravesites each with a gravestone, more specifically to graveyard systems including a website associated with a graveyard that comprises gravesites with gravestones, where the graveyard has at least one camera.

### BACKGROUND

A variety of different ceremonies and memorials have been used to commemorate the death of an individual (hereafter a deceased), where the ceremony and memorial are generally organized by one or more of the family of the deceased. Ceremonies and memorials have become commonplace for helping the living cope with the loss of the deceased, and for commemorating the deceased for future generations. For example, traditional western country ceremonies typically involve a funeral home visitation, a burial, and a wake, with the gravesite being marked by a headstone also known as a gravestone, referred to herein as a gravestone, that includes the name of the deceased thereon along with the deceased's day of birth and the date of death.

Traditional ceremonies and memorialization events require visitors to be physically present at the funeral ceremony or memorial around the gravesite to view or reflect on the deceased. If one is not physically present at the funeral ceremony or the memorial, that individual cannot conventionally share in the achievements and memories associated with the deceased. The duration of a traditional funeral ceremony is limited to the actual time of the actual ceremony.

Conventional gravestones are formed from only a carved stone. Such conventional gravestones do not allow any remote viewing, or for any remote modification(s) to be performed to the gravestone or to the gravesite.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed aspects include a remote gravesite experience (RGE) system and a method of experiencing a user-selected gravesite remotely. The method includes providing an RGE system comprising a website having an associated server that is communicably coupled to receive information and control at least one feature associated with a graveyard that comprises a plurality of gravesites each including a gravestone including a first gravesite comprising a first gravestone. The graveyard has at least a first camera that has a first field-of-view (FOV) which is positioned for viewing the first gravesite. A user having a computing device, comprising a processor and an associated memory, a transceiver, and a display screen, initiates a connection over a network to the website. The website is configured for controlling access to the first FOV, such as by a user registration process implemented by the website.

Once registered, the user can select to view on their display screen the first gravesite provided by the first FOV. The network utilized can generally utilize an Internet protocol (IP) connection. The gravesites can also include a microphone(s) that provide audio data from around the first gravesite. The gravestones can include a plurality of lights, where the web site can also enable the user to also remotely control an illumination pattern involving any of the lights.

### BRIEF DESCRIPTION OF THE DRAWINGS

FIG. 1 shows an example RGE system comprising a graveyard including a plurality of cameras that collectively provide a FOV showing a selected gravesite shown as a first gravesite that includes a first gravestone, where the RGE system includes a website including an associated server, and where the website is coupled to receive image data from the plurality of cameras positioned to image the first gravesite.

FIG. 2 shows an example gravestone having a plurality of disclosed features including a light source that can comprise an array of light-emitting diodes (LEDs) that can be configured as memorial lights, and a nameplate that has name information for a deceased. The gravestone may comprise an optically transparent material where there are solar modules including battery packs for the light sources are embedded within the optically transparent material. The light sources can be weatherproof and the solar module can provide electrical power for powering the light sources enabled by the top of the gravesite comprising an optically transparent material, so that sunlight can reach the solar module to generate electrical power for the light sources.

### DETAILED DESCRIPTION

Disclosed embodiments are described with reference to the attached figures, wherein like reference numerals, are used throughout the figures to designate similar or equivalent elements. The figures are not drawn to scale and they are provided merely to illustrate aspects disclosed herein. Several disclosed aspects are described below with reference to example applications for illustration. It should be understood that numerous specific details, relationships, and methods are set forth to provide a full understanding of the embodiments disclosed herein.

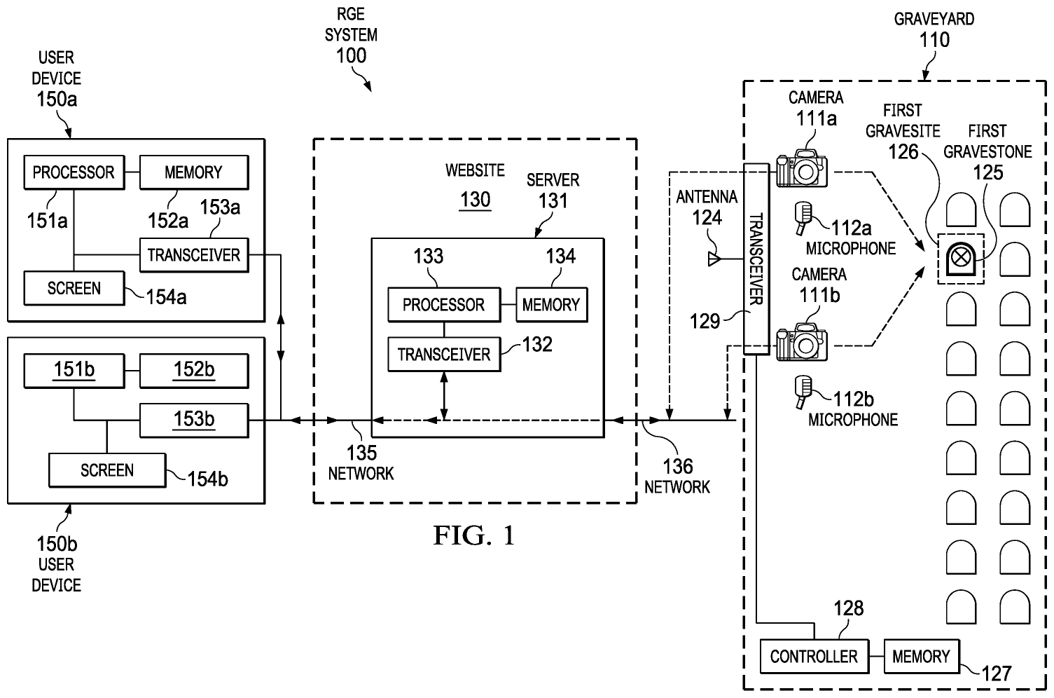

FIG. 1 shows an example RGE system 100 comprising a graveyard 110 including a plurality of cameras 111a, 111b that collectively provide a FOV showing at least a selected gravesite shown as a first gravesite 125 that includes a first gravestone 126. There are also optionally shown a plurality of microphones 112a, 112b that sense audio data from around the first gravesite 125. The RGE system 100 is configured to provide a user the remote experience of attending a funeral either at the time of the actual funeral or at some time thereafter.

The RGE system 100 includes an interactive website (website) 130 including an associated server 131, a transceiver 132, and a computing system comprising at least one processor 133 having an associated memory 134. The website 130 is coupled (e.g., an IP network connection) to receive image data from the cameras 111a, 111b, and also to receive audio data from the microphones 112a, 112b that sense sound around the first gravesite 125 including around the first gravestone 126.

The graveyard 110 also includes at least one controller 128 that comprises a processor having an associated memory 127, where the controller 128 is coupled to a transceiver 129 that enables the data obtained from the cameras 111a, 111b and data from the microphones 112a, 112b to reach the network 136, and for information sent by the website 130 to reach the controller 128. For example, information from the website 130 can comprise instructions for controlling at least one aspect associated with the graveyard 110, such as the FOV of the cameras 111a, 111b. The transceiver 129 is shown coupled to an antenna 124 to enable wireless communications. More generally, in the case of wireless communications being utilized in the RGE system 100, although not shown, all system components will also include an antenna coupled to the transceiver, such as the user devices 150a, 150b.

The user devices 150a and 150b, each include a processor 151a, 151b each having an associated memory 152a, 152b, a transceiver 153a, 153b, and a display screen 154a, 154b. The display screens 154a, 154b generally occupy substantially the entire area of the user devices 150a, 150b.

The cameras 111a, 111b can comprise what is commonly termed surveillance cameras that can provide an FOV of at least 100°, such as an FOV of 110°. Analogous to a traditional camera, there are commercially available surveillance cameras that include the feature of adjustability of their focus and FOV realized by physically moving the lens(es) closer or further from the scene being recorded, generally known as a varifocal lens. There are also commercially available security cameras with varifocal lenses that can be adjusted for a wider FOV or narrower FOV by simply turning a screw, and some commercially available security cameras are configured for remote control of the FOV when the camera includes an antenna, transceiver, and a motor including a motor controller configured for receiving a wireless signal for adjusting the lens(es) to change the FOV. A motor controller can also receive a wireless signal for adjusting the position of the camera. To provide a reasonable resolution, the cameras can be selected to provide at least 2 megapixels (MP). Optionally, the cameras can include night vision provided by including an infrared illumination source.

The website 130 comprises an associated server 131 comprising a processor 133 with a memory 134 and a transceiver 132 shown connected to a first network 135 and a second network 136 configured so that the user device 150a and user device 150b are also both connected to the second network 136 that the cameras 111a, 111b and microphones 112a, 112b are also connected to. The RGE system 100 provides a user remote viewing of a selected gravesite shown as first gravesite 126 having the first gravestone 125, and control of the first gravestone 125 to provide a user having a user device 150a or 150b the ability for remote real-time viewing provided by the camera(s) 111a, 111b having a FOV including the first gravestone 125.

A user utilizing the website 130 can also remotely modify at least one feature of the first gravestone 125. This modification feature can be accomplished by retrofitting an already existing gravestone, or as the original design of a gravestone with this feature(s) already incorporated so that retrofitting a gravestone is not needed. The website 130 will generally be programmed so that visitors will need to login, and generally pay a fee, to become registered as a user so as to restrict access to the website 130, and to avoid actions that can result in an identity theft or identity distortion of the deceased.

A website such as website 130 is known to be a collection of web pages and related content that is identified by a common domain name and published on at least one web server. Disclosed websites such as website 130 as described below are dynamic/interactive websites because they permit changes or customization, such as the addition of information regarding a deceased. Disclosed websites are available to registered users on the Worldwide Web. A disclosed website 130 is dedicated to a remote gravesite experience, and generally provides hyperlinking between web pages which guides the user through navigation of the website 130, which generally starts the interaction with a home page. Registered users may access a disclosed website 130 on a wide range of user devices 150a, 150b, including a desktop, laptop, tablet, or a smartphone. The software application used on these user devices 150a, 150b is commonly called a web browser.

Disclosed RGE systems such as RGE system 100 can operate in real-time as well as virtually, and with website 130 being an interactive website having an associated server 131 allows a user to “visit” a deceased associated with a selected gravesite, typically a deceased family member. No matter where the user physically is or what time it, assuming a connection to the network 135 is available to the user, the user can connect to the website 130 of the RGE system 100 to enable the user to check-in and remotely visit the gravesite of their choice that is listed on the website 130, such as the website 130 being indexed by name and thus being searchable by name.

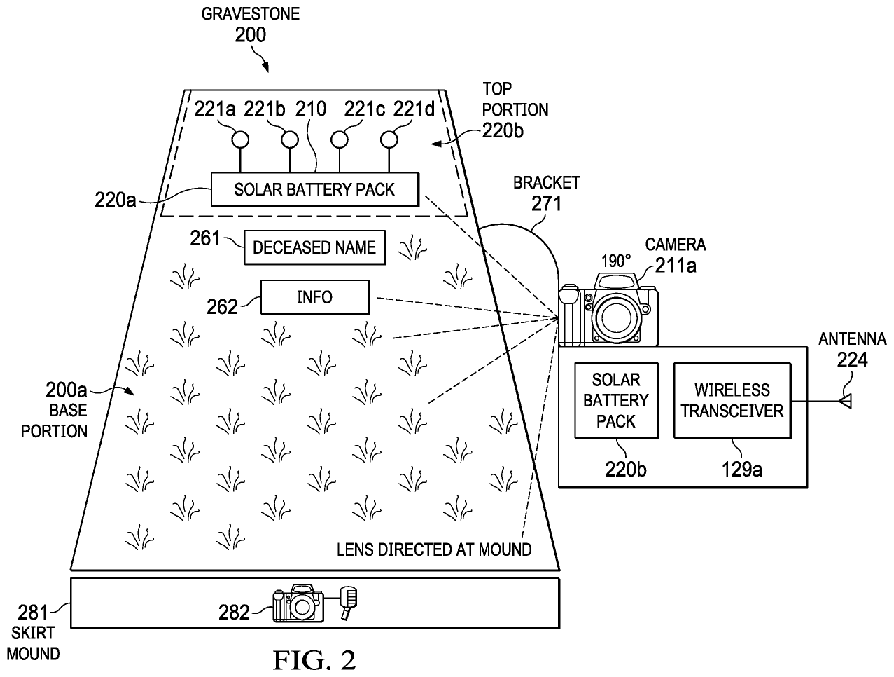

For the funeral itself, RGE system 100 can create a funeral experience. The funeral experience generally includes visual from the cameras 111a, 111b and audio from the microphones 112a, 112b including around the first gravesite 126 for the funeral ceremony, as well as a stored archive of the funeral and salutations from all, incorporating a user's/visitor's log, and future access to all registered users. Following the actual funeral, access to the website 130 generally includes real-time visual from the cameras 111a, 111b and optionally also audio access provided by the microphones 112a, 112b to the actual gravesite. As noted above, the camera(s) 111a, 111b can be powered by a solar charged battery pack (see FIG. 2 described below) to enable operation where conventional electrical power is not otherwise available.

The networks 135 and 136 can both comprise an IP network, that can each generally be provided over cables or wirelessly (RF) over the air, configured for the website 130 to receive and store image data from the plurality of cameras 111a, 111b and store audio data from microphones 112a, 112b. This information storage that is generally index by the deceased's name, can provide a user at the time of the funeral service or any time thereafter a remote experience of attending a funeral or otherwise physically being at a gravesite of interest.

The remote gravesite experience provided by RGE system 100 can be provided through a fee (such as using a credit card or a service such as PAYPAL) to the user application run on a user device 150a or 150b which can be made available to smartphones and related communication devices such as for IPHONES and IPADS, ANDROID phones and tablets, or generally any WINDOWS computer or tablet, which connect to the system's wireless internet connection or camera for remote locations. Since all RGE system 100 components other than the server 131 and other components associated with the website 130 that are generally outdoors can use weatherproof material with solar powered batteries, so there is no external wiring required for the RGE system 100 components including the gravestones, cameras, or for the microphones.

The website 130 being coupled (for example by an IP connection) to receive image data from the cameras 111a, 111b and audio data from the microphones 112a, 112b provide a user the experience of attending an actual funeral ceremony. This funeral ceremony event can be uploaded to the website 130 which has associated files in its memory 134 that are specific to the specific gravesites, with the option of using longitude and latitude-based location. This can create an ongoing library or archive regarding a plurality of deceased's which can be ongoing and can be accessed by loved ones of the deceased from the time of the file creation or at a later time.

A disclosed user application can generally be installed easily on any user device 150a, 150b. All that is generally needed is placing a camera(s) 111a, 111b around the gravesite at a location which allows the view of the front side of the gravesite and the surrounding area, which extends the user's experience. A remote access account for the user can be created on the website 130 that is configured for providing the user continued FOV of the selected gravesite including a gravestone, thus enabling the user a viewing of the selected gravestone (and optionally audio data) either live or from the cloud or pre-established site for access by associated visitors or offering additional applications attributed to the gravesite associated with the selected gravestone.

Access to the selected gravestone can be accomplished by use of a variety of user devices 150a, 150b including smartphones or other similar devices as described above running an application that can be downloaded from a disclosed website 130. This feature allows a user to establish access to a disclosed website 130 that enables a view of the gravesite, as well as sending messages or uploading information such as memorials (such as images including deceased) to the website 130.

A disclosed website 130 can provide visual/audio communication, visitor notifications (on-site), and online functions to turn on memorial (visiting) light (both real-time and on the website) configured to control the light sources, enabling the user a level of control. An option can also be included for turning any combination of the light sources on the gravesite (see FIG. 2 described below that shows a gravestone 200 that includes a plurality of light sources 221a-221d).

When an individual visits the website 130, they can notify others, such as family or friends, or be notified by a text and/or email alerts as well who are connected to the website 130, or there can be the option to remain anonymous (or private). This feature can provide a user the remote experience of attending annual occasion visits to their departed loved ones. Multiple visitors may access the website 130 simultaneously, and the website 130 is also configured to support creation of a “chat room” that enables communication between users associated with a given deceased. Disclosed RGE systems 100 as described above also generally include visual/audio communication (as well as live video or real-time) on a user's device 150a, 150b, such as a smartphone or a computer for any mutual occasion visits for example the deceased's birthday, anniversary, at any time when certain individuals cannot be actually at the gravesite.

FIG. 2 shows an example gravestone 200 comprising at least a top portion 200b that includes optional optically transparent material in the top portion 200b which is shown on top of a base (or bottom) portion 200a. The gravestone 200 includes light sources shown as 221a, 221b, 221c, 221d which can comprise LEDs that are configured to provide a user-selectable array of memorial lights. The gravestone 200 includes a solar-powered battery packs 220a for providing electrical power to light sources 221a-d, which can be embedded within or under the optically transparent material of the top portion 200b.

The gravestone 200 is also shown including a solar powered battery pack 220b and a wireless transceiver 129a couple to an antenna 124 associated with the camera 211a. The camera 211a is shown secured to the gravestone 200 by a mounting bracket 271. There is also shown a skirt mound 281 that extends outside an area of the gravestone 200, and a relatively small camera 282 positioned just outside on a bottom side of the base portion 200a. The camera 282 is configured to provide a wide-angle that may be affixed to the gravestone by an angle or can be affixed to the skirt mound 281, where a lens of the camera 282 can be directed to image a selected portion of the gravestone 200. Although not shown, camera 282 can also include a solar battery pack, wireless transceiver, and an antenna, analogous to the camera 211a.

The light sources 221a, 221b, 221c, 221d are weatherproof, and enabled by the optically transparent top portion 200b provide solar-power generated by the solar powered battery pack 220a. Sunlight during the daytime when available can be transmitted through optically transparent material in the top portion 200b so that the sunlight reaches the solar cells in the solar module of the solar powered battery pack 220a, such as comprising a lithium ion battery pack, which generates electrical power for powering the respective light sources 221a-d. The gravestone 200 is shown including a nameplate 261 for the deceased name a location for additional information shown as info 262 regarding the deceased, such as the deceased's date of birth and the date of death.

Disclosed RGE systems generally enable users to upload information to the website 130, such as events associated with the deceased. This enables the users to save items in files in the memory 134 associated with the website 130 to enable viewing contents of a stored file including a biography of the deceased and viewing stored images of the deceased associated with the selected gravestone. This also enables letting other users view those recordings of selected prayers from the prayer menu triggers, to provide a recital of the prayers or provide a writing of the selected prayer expressed in one or more languages, historical biography or simply hearing some salutation or message in the voice of the deceased (if available), which may be accessed by users of the website 130.

The user's remote visit to a selected gravesite can serve as a prayer visit or remembrance, and the viewing aspect provided by a camera(s) 111a, 111b viewing the selected gravesite will also allow the user to check on gravesite aspects, such as for checking for proper perpetual maintenance care. For example, overgrown vegetation can be identified by a user from the images provided by the cameras 111a, 111b so that it can be reported to enable it to be promptly corrected, such as by notifying the operator of the graveyard 110.

With a click on the touch screen of a user device 150a, 150b that communicably connected to the website 130 of a disclosed RGE system 100, the RGE system 100 is generally configured so that one can leave a lit light such as an icon by a disclosed application that shows one's respect and love for a deceased. The RGE 100 system can enable a user to choose a symbol such as a religious symbol, flowers, rock, angel, or visitor's name that will light up and stay lit up for a period of time, such as in one specific example for a period of 30 days.

In addition, RGE systems 100 enable users to experience virtual funerals for those individuals that cannot attend a funeral, but a record of visitation can be kept at the website 130. Such records of visitation will enable loved ones of the deceased to know that the remote user was ‘there’ and supporting and participating in an interactive screen analogous to a facetime or a GOTO meeting.

Some individuals have preplanned and purchased cemetery plots in earlier times in life when things were different. Disclosed websites 130 can also be used to resell unused cemetery plots by enabling remote viewing of the cemetery plots on their user device. The idea of “Ring” is an applicable use of technology to be applied or something analogous to a smart house.

A feature of RGE system 100 is the ability to visit one's dearly departed. Other features include perpetual maintenance and remembrance. Additionally, other needs and interests provided by disclosed RGE systems such as RGE system 100 are described below.

With a disclosed website 130 one can visit any day or any time to keep the connection, remembrance and honor of a deceased. There is a plurality of advantages provided by a disclosed RCE system 100 that includes a website 130 configured for a user remotely visiting of a selected gravesite:
1. One can remotely visit a selected gravesite anytime, essentially instantaneously.
2. One can show their respect, such as by turning on a light or a plurality of lights associated with the gravestone, such as for representing a remembrance symbol.
3. A family/group can meet online at a disclosed website 130 and together pray over a holiday, a birthday, or other significant date for the deceased.
4. By viewing around the first gravesite 126 one can identify problems, that enable a follow-up and a check regarding the proper maintenance of the gravesite plot.
5. The website 130 can include a recorded biography or memories of the deceased that can come up as a way to immortalize the deceased and what they or a family member would like to share. In addition to this service, disclosed websites 130 can be used for:
6. Resale of gravesite plots.
7. A virtual funeral for those individuals that would attend, but could not attend but would partake and can create a virtual lobby at some time after the actual funeral service.

While various disclosed embodiments have been described above, it should be understood that they have been presented by way of example only, and not as a limitation. Numerous changes to the disclosed embodiments can be made in accordance with the Disclosure herein without departing from the spirit or scope of this Disclosure. Thus, the breadth and scope of this Disclosure should not be limited by any of the above-described embodiments. Rather, the scope of this Disclosure should be defined in accordance with the following claims and their equivalents.

1. A method of remotely experiencing a gravesite, comprising:
providing a remote gravesite experience system comprising a website having an associated server that is communicably coupled to receive information and control at least one feature associated with a graveyard that comprises a plurality of gravesites each including a gravestone including a first gravesite comprising a first gravestone, wherein the graveyard has at least a first camera having a first field-of-view (FOV) positioned for viewing the first gravesite;
a user having a computing device comprising a processor, and associated memory, a transceiver, and a display screen, the computing device initiating a connection over a network to the web site;
wherein the website is configured for controlling access to the first FOV, and
the user selecting to view on the display screen the first gravesite provided by the first FOV.

2. The method of claim 1, wherein the first gravestone includes at least one light source, and wherein the web site is configured for enabling the user to control at least one feature of the light source including the user controlling a light pattern associated with the light source.

3. The method of claim 1, further comprising the user after viewing the first gravestone directing maintenance to be performed on the first gravestone.

4. The method of claim 1, wherein the first camera is configured to enable the first FOV to be changeable, further comprising the user changing the first FOV.

5. The method of claim 1, wherein multiple ones of the user can simultaneously share the first FOV provided by the first camera.

6. The method of claim 1, wherein the graveyard further includes a first microphone located proximate to the first gravestone that is communicatively coupled to the website, further comprising the user selecting from the website to receive audio generated by the first microphone.

7. The method of claim 1, wherein the website provides a list of prayers that are provided to the user based on a menu, further comprising triggering a recital of the prayers or a representation of the prayers displayed on the display screen in at least one language.

8. The method of claim 1, wherein the website includes a memory that includes storage of files for a deceased enabling the user to deposit information in the files accessible by entering the information including a name for the deceased, and to view contents of the files associated with the deceased.

9. The method of claim 2, wherein the at least one light source comprises a plurality of light sources, wherein the gravestone includes a top portion that comprises an optically transparent material, wherein the plurality of light source is embedded within the optically transparent material along with a solar module coupled to power the plurality of light sources.

10. A remote gravesite experience system, comprising:
a website having an associated server that is communicably coupled to receive information and control at least one feature associated with a graveyard that comprises a plurality of gravesites each including a gravestone including a first gravesite comprising a first gravestone, wherein the graveyard has at least a first camera having a first field-of-view (FOV) positioned for viewing the first gravesite;
wherein the website is configured for a user having a computing device comprising a processor, and associated memory, a transceiver, and a display screen, for the computing device initiating a connection over a network to the website, and
wherein the website is configured for controlling access to the first FOV, and
for the user selecting to view on the display screen the first gravesite provided by the first FOV.

11. The system of claim 10, wherein the first gravestone includes at least one light source, and wherein the website is configured for enabling the user to control at least one feature of the light source including the user controlling a light pattern associated with the light source.

12. The system of claim 10, wherein the first camera is configured to enable the first FOV to be changeable, further comprising the user changing the first FOV.

13. The system of claim 10, wherein multiple ones of the user can simultaneously share the first FOV provided by the first camera.

14. The system of claim 10, wherein the graveyard further includes a first microphone located proximate to the first gravestone that is communicatively coupled to the website, further comprising the user selecting from the website to receive audio generated by the first microphone.

15. The system of claim 10, wherein the website provides a list of prayers that are provided to the user based on a menu, including a recital of the prayers or a display of the prayers on a display screen in at least one language.

16. The system of claim 10, wherein the website includes a memory that includes storage of files for a deceased enabling the user to deposit information in the files, wherein the files are accessible by the user entering a name of the deceased which results in providing the user on a user device a view of the files.

17. The system of claim 10, wherein the at least one light source comprises a plurality of light sources, wherein the gravestone includes a top portion that comprises an optically transparent material, wherein the plurality of light sources is embedded within or under the optically transparent material along with a solar module coupled to power the plurality of light sources.
